(19) United States
(12) Patent Application Publication
(10) Pub. No.: US 2007/0250370 A1
(43) Pub. Date: Oct. 25, 2007

(54) Scheduling application and distribution method

(76) Inventors: Laila Partridge, Wellesley, MA (US); Patricia Ann Cohen, Arlington, MA (US)

Correspondence Address: GOODWIN PROCTER LLP;PATENT ADMINISTRATOR, EXCHANGE PLACE, BOSTON, MA, 02109-2881, US

(21) Appl. No.: 11/786,749

(22) Filed: Apr. 11, 2007

Related U.S. Application Data
(60) Provisional application No. 60/790,885, filed on Apr. 11, 2006.

(51) Int. Cl. G06F 9/46

(52) U.S. Cl. 705/8

(57) ABSTRACT

A scheduling application providing information and management through SMS messaging and other related communication methods is proposed. The application can allow a user to create and modify a database of user contact and schedule information, and then utilize this information to produce a schedule for a select group of users. Information related to this schedule can then be communicated to the users through the stored contact information, and modifications and updates to the schedule can be made based on user response.

### CROSS-REFERENCE TO RELATED APPLICATIONS

This application claims priority to, and the benefit of, U.S. provisional patent application Ser. No. 60/790,885, filed on Apr. 11, 2006, the disclosure of which is incorporated herein by reference in its entirety.

### FIELD OF THE INVENTION

The present invention relates generally to the field of electronic scheduling and rescheduling and, more particularly, to a web or other electronic based calendar and scheduling and rescheduling application providing information and management through wireless messaging and other related communication methods.

### BACKGROUND OF THE INVENTION

Providing a means of communicating information, and receiving information from multiple remote users, can be of great importance in the successful management of a business. For businesses that include multiple offsite personnel, such as sales or service staff, arranging meetings or other events for multiple employees can be a difficult and time consuming problem.

Many companies have addressed this problem by providing their employees with portable electronic devices that can, amongst other uses, send and receive email messages over the internet. This enables companies to communicate quickly with employees anywhere that the portable electronic device can receive service. However, these devices can be expensive, and therefore may not be available to small businesses, start-up companies, and private groups or clubs that do not have the finance necessary to provide such devices to their employees or members, or do not have the need for such complex multi-function communication devices.

However, with the growth of cell phone usage in recent years, it has become possible to quickly and easily communicate with individuals anywhere in the world that wireless telecommunication services are available, either through voice and/or SMS messaging. This technology allows businesses to maintain contact with their employees, but has generally been utilized only passively to either communicate individually with each employee, or send information to employees that they then have to act on individually. Therefore, although cell phone technology permits communication between multiple users at remote locations, scheduling events for these multiple users can still be time consuming, complicated, and expensive.

The growth in the use of cell phones, especially among high school and college students, also means that a significant percentage of people entering the workforce are comfortable with the use of SMS messaging or other mobile communication mode, and can easily be contacted through SMS messages, instant message (IM), or email on their personal cell phones at any time. The development of a tool to utilize this technology to better serve both employers and potential employees, especially in fields such as retail and catering where employers often need temporary staff on short notice, could be of great benefit in the workplace.

Additionally, while office workers frequently use electronic calendaring or scheduling applications, it is less common for a high school or college student or individuals like hourly workers without daily access to a computer to maintain an electronic calendar. Thus, it is more difficult for an employer or other scheduler to create and manage a schedule and subsequent reschedules for such users. This same demographic often values flexibility in their daily activities, which often results in making last minute changes to personal or work activities to attend a more attractive event or activity. Thus an ability to enable such users to have access to some form of an electronic calendar function (perhaps to provide input for their preferences for a given work schedule), and then to be able to change that work schedule (adding more or less work hours) close to the actual schedule event would be of use to an employer with a large pool of such workers. To enable last minute rescheduling for users, such a scheduling tool could take advantage of multiple communications modes and in particular a mechanism such as SMS text messaging where a user is always connected but can selectively choose when to respond or not respond. Since this demographic does not generally keep calendars and makes last minute changes which might effect a future date, reminders or notifications of schedules or reschedules would be helpful.

One characteristic of schedules is that once created, they generally do not stay static. Almost as soon as a schedule is generated, some worker or event requires a change to that initial schedule. It is this rescheduling function that is generally the most time consuming aspect of maintaining and managing any given schedule.

Accordingly, a need exists for a method of providing an electronic calendar and scheduling application that can automatically create and manage scheduling events for multiple remote users, and automatically receive and act on responses from remote users for the purposes of rescheduling, through simple and widely available cell-phone technology, without it being necessary to provide users with additional and possibly expensive wireless communication equipment.

### SUMMARY OF THE INVENTION

The current invention describes a method of creating, communicating, updating, and confirming a schedule for a number of remote users through SMS text messaging or other appropriate remote communication.

Such an application can be of great benefit to businesses such as those that include multiple off-site personal, wherein quickly communicating with remote personnel and organizing meetings, temporary work assignments, or events may be difficult. By creating a schedule for a number of people from a database of personnel schedules, which themselves can be easily created and/or updated or rescheduled remotely, then sending this proposed master schedule to the relevant group of users simultaneously or placing it electronically on the web, on another electronic or wireless device, such as a device incorporating SMS messaging or another appropriate form of electronic messaging or notification, or other location where it can be easily retrieved, a schedule can quickly be communicated to multiple remote users with minimum time and effort. This initial schedule can then be rescheduled though a process of updating, changing, and/or confirming based on responses sent by return SMS message, or other appropriate communications, from the remote users.

Another unique characteristic of hourly workers who work in retail or other service sectors is that they often have more than one employer. Since these same workers may not maintain electronic or paper calendars, there is value to a product or service that helps them keep track either individually or in a collated format all their various jobs. Such an application can provide a single source where such scheduling information could reside and be managed optimally for the benefit of that individual worker.

One aspect of using various modes of communications is the ability to expand the number of users under consideration in the rescheduling process. Specifically, rather than a sequential single communication between a manager and a worker or two workers for any reschedule, a manager or worker can, via the application, reach multiple, appropriately filtered users in multiple communication modes to garner the optimal scheduling change. This might entail waiting a given period to get a number of workers to choose from and then use performance ranking or financial considerations like overtime or any other reason to select the best worker for the scheduling change. Additional steps could also be introduced to the process like an approval or notification of any change by a manager. In a situation where a manager does not approve a given scheduling change, they might be able to inquire if other workers had also responded to the reschedule request and thus choose amongst others in the queue.

Reminders or notifications play an important role in communications of schedules and/or rescheduling. Certain workers and their managers like reminders of their upcoming scheduling events others prefer to be notified only of changes or reschedules to that initial schedule. This is because many of hourly workers do not generally use or maintain calendars.

The ability to use ubiquitous electronic or communication technologies to enable easier and optimal rescheduling either automatically or manually by the manager or amongst individual workers themselves can be a valuable and time saving function. There can be additional value in automating certain functions around rescheduling like allowing a manager to approve or at least be notified of the specifics of rescheduling before those changes are finalized.

In addition to using communications to facilitate initial scheduling and later rescheduling, there is an opportunity to use the electronic data and business intelligence collected from those activities to develop heuristic models for future scheduling and rescheduling.

In one embodiment of the invention, a scheduling application could track the underlying business intelligence associated with these communications between users in the course of scheduling or rescheduling. One approach would be to observe the usage patterns in the initial creation of schedules by various scheduling managers and subsequent rescheduling. Another approach would be capture certain underlying business intelligence patterns associated with communications or manual inputs around scheduling and rescheduling. Uses for such captured business intelligence patterns might be to automatically create a more optimal future schedule or reschedule. Other uses for such patterns might include measuring the job performance of individual workers and possibly ranking those workers relative to each other. This ranking could in turn be used to reward better performing workers with their preferred work hours in a given schedule or reschedule. This ranking might also be used to incent lesser performing workers to reduce undesirable behavioral patterns like tardiness, absenteeism or turnover.

One aspect of the invention includes a method for generating a schedule through electronic communication. The method can include the steps of accessing stored contact and scheduling information for at least one party, selecting at least one time within a calendar based on the stored scheduling information for the at least one party, sending an electronic request to the at least one party regarding availability at the at least one selected time, collating responses to the electronic request, and generating a scheduling calendar based on responses to the electronic request.

Another aspect of the invention can include a method of scheduling a task. The method can include the step of receiving a task request from at least one requesting party, wherein the task request includes at least one task requirement. The method can further include the step of providing a means of scheduling at least one worker to perform the task wherein the scheduling means includes electronic communication. The method can also include the steps of sending at least one notification of the scheduling of the task, wherein the notification includes electronic communication, and providing a means of updating the scheduling of the task, wherein the updating means includes electronic communication.

In one embodiment, the task requirement can include at least one of a time, a date, a location, a skill set, a qualification, and a performance metric. The means of communicating the electronic communications can include at least one of an email message, an SMS message, a phone message, an instant message (IM), a posted webpage message, an internet chat-room message, and a portal broadcast message to application users. In general, the electronic communication can include any appropriate wireless communication, a communication through any appropriate wired or cabled connection, or any other appropriate communication system. In one embodiment, a plurality of means of communicating the electronic communications may be used substantially simultaneously.

In one embodiment, at least one of the means of scheduling at least one worker and the means of updating the scheduling of the task can include an at least partially automated process. At least one of the means of scheduling at least one worker and the means of updating the scheduling of the task can further include an at least partially manual process. The at least partially manual process can include an input from the at least one requesting party. Alternatively, or in addition, the at least partially manual process can include an input from an application administrator and/or an input from at least one worker.

In one embodiment, the scheduling means can include the steps of accessing information stored in a database for a scheduling application for at least one prospective worker, generating a list of suitable prospective workers based on the information stored in the database, sending a scheduling request to at least one of the suitable prospective workers through at least one electronic communication, receiving a response from at least one of the selected suitable prospective workers, and selecting at least one worker for the task based on the received responses.

In one embodiment, the at least one notification can include an electronic communication to at least one of the requesting party, the at least one scheduled worker, and the selected suitable prospective workers. The information stored in the database can include at least one of contact information, scheduling information, skill set information, qualification information, and performance metric information. The performance metric information can include at least one of a timekeeping history, a performance history, a skill set, a willingness to accept tasks, and a willingness to perform accepted tasks.

In one embodiment, the rescheduling means can include the steps of receiving a rescheduling request from at least one of the at least one requesting party and at least one scheduled worker, accessing information stored in a database for a scheduling application for at least one prospective replacement worker, generating a list of suitable replacement workers based on the information stored in the database, sending a scheduling request to at least one of the suitable replacement workers through at least one electronic communication, receiving a response from at least one of the selected suitable replacement workers, and selecting at least one replacement worker for the task based on the received responses.

Another aspect of the invention can include a method of scheduling coverage for a task. The method can include the steps of storing schedule information for at least one worker in at least one database for a scheduling application and receiving a coverage request from at least one requesting party, wherein the coverage request can include at least one task requirement. The method can further include the steps of matching the at least one task requirement with the stored schedule information to produce a list of suitable workers, selecting at least one suitable worker from the list of suitable workers, and providing a means for the at least one suitable worker to accept the task.

The task can be a specific job, a series of jobs, a portion of a job, a scheduling, an exchange or swap, a rescheduling, or any other appropriate work and/or work function. In one embodiment, one or more databases can be incorporated directly into a scheduling application. In another embodiment, one or more databases may be stored separately and accessed by a scheduling application.

In one embodiment, the method can further include the step of providing a means for rescheduling a previously accepted task. In one embodiment, the method can further include the step of providing a means for swapping one or more accepted tasks between suitable workers.

The stored schedule information can include at least one of contact information, scheduling availability information, skill set information, qualification information, and performance metric information. The selecting step can include ranking the list of suitable workers according to at least one of the skill set information, the qualification information, and the performance metric information. The performance metric information can include at least one of a timekeeping history, a performance history, a skill set, a willingness to accept tasks, and a willingness to perform accepted tasks. This ranking system can also include a rewards system to incent workers to alter behavior which may reduce tardiness, absenteeism, or turnover for the employer.

In one embodiment, the method can further include the step of providing a means for updating at least one piece of the stored schedule information for the at least one worker. In one embodiment, the at least one piece of stored schedule information can be updated by at least one of the at least one worker and the at least one requesting party.

In one embodiment, at least one of the receiving step, the matching step, the selecting step and the providing step is at least partially automated. In one embodiment, the method can further include the steps of analyzing at least one of the stored schedule information, a database of stored task request information, and a database of stored task acceptance information, creating a heuristical model in response to the analyzed information, and incorporating the heuristical model into a means of executing the at least one partially automated step.

In one embodiment, the method can further include the steps of analyzing data associated with the usage of at least one function of the scheduling application, creating a heuristical model in response to a pattern of usage, and incorporating the heuristical model into a means of executing the at least one partially automated step.

In one embodiment, at least one of the at least one database and the scheduling application can be stored, controlled, and/or accessed on a portable electronic device, such as a handheld computer, a laptop, a personal digital assistant, a mobile phone (such as a Wireless Application Protocol (WAP) enabled, or non-WAP enabled mobile phone), or any other appropriate portable electronic device. In one embodiment, the method can further include the step of providing a means for communicating advertising information to the at least one worker in the at least one database. This can, in one embodiment, include sending one or more targeted advertising messages to a worker, or a group of workers, based on information about the worker(s) stored in the scheduling application database. The advertising messages may include any appropriate text and/or graphics related to a product or service.

Another aspect of the invention can include a task scheduling system. The task scheduling system can include at least one database adapted to store scheduling information for at least one worker and a scheduling application for scheduling at least one task. The scheduling application can include a means of retrieving scheduling information stored in the at least one database and a means of receiving a coverage request from at least one requesting party, wherein the coverage request can include at least one task requirement. The task scheduling system can further include a means of matching the at least one task requirement with the stored schedule information to produce a list of suitable workers, a means of selecting at least one suitable worker from the list of suitable workers, and a means for the at least one suitable worker to accept the task.

In one embodiment, the task scheduling system can further include a means of updating scheduling information stored in the at least one database. In one embodiment, the task scheduling system can further include a means for rescheduling a previously accepted task. In one embodiment, the task scheduling system can further include a means for swapping one or more accepted tasks between suitable workers.

In one embodiment, the task scheduling system can further include a means for storing a plurality of separate job schedules for the at least one worker. This means for storing the plurality of separate job schedules can include a means of collating at least two of the plurality of separate job schedules into a single calendar for review by the at least one worker. As a result, a worker can create and manage a plurality of work schedules for a plurality of different jobs and/or employers from a single scheduling application. This can include allowing the worker to view and update each schedule independently and/or together in a single scheduling calendar. In one embodiment, at least some of the plurality of schedules can be merged or separated for ease of viewing and/or managing. In one embodiment, a worker can provide different priorities to each of the plurality of schedules, allowing tasks to be assigned to the worker based on the workers priorities. These priorities may be based on at least one of a time, a location, an employer, a job, a pay scale, or any other appropriate work priority. These priorities can, in one embodiment, be included in the stored scheduling information that is taken into account when matching a worker with a specific task request.

In one embodiment, the task scheduling system can further include a means of prioritizing one or more job schedules within the plurality of separate job schedules. This prioritizing means may include, for example, considering at least one of availability and/or preference information.

In one embodiment of a scheduling application for managing multiple jobs for an individual worker, the worker can view all of his or her scheduling information in one or more electronic views on a webpage, laptop, PDA, cell phone or other appropriate platform, such as another handheld or wireless device. The schedules from multiple jobs can be presented individually or combined into one master schedule for the worker.

In another embodiment of a scheduling application for managing multiple jobs for an individual worker, the worker can input his or her preferred work times in one location on the application and have the application manage the distribution of such inputs amongst the different jobs. In one embodiment, as schedules can be generated by the various jobs, the application can automatically update the worker's availability to work for the as yet unscheduled jobs. In one embodiment the worker might give specific guidance as to how the application should prioritize job scheduling. In that example, if the worker worked at Job 1, Job 2 and Job 3, for example, and he preferred to work as many hours as possible at Job 2, but Job 1 scheduled before Job 2, the application could choose to allow two jobs to be scheduled at overlapping or conflicting times. In such an instance the application can notify the worker of a scheduling conflict and assist the worker in finding a cover for the less desirable job. In that same instance, the time availabilities granted for Job 1 and Job 2 would automatically be removed from the worker's time availability for Job 3. Alternatively, the worker might have little tolerance for conflict and might instruct the application to disallow any scheduling conflicts by filling time availability on a first-come-first-serve basis.

Another aspect of the invention can include a method for generating a schedule through electronic communications. The method can include the steps of accessing stored contact and scheduling information for at least one party, sending an electronic request to at least one party requesting availability for a given period of time, and receiving an electronic input of one or more parties availability. The method can further include the steps of collating responses to the electronic inputs, electing at least one time within a calendar based on the stored scheduling information, selecting one or more parties available for the selected time or other times, generating a scheduling calendar based on selection or selections, and sending a notification to at least one party related to the scheduling calendar.

In one embodiment, the notification can include a message notifying a user that a schedule is complete, notifying a user to check a schedule, and/or reminding a user of an upcoming work shift.

Another aspect of the invention can include a method for using electronic communications to find coverage of one or more parties scheduled time with another party. The method can include the steps of receiving an electronic communication from one or more parties either directly or through the one or more party logging onto an electronic schedule application through an internet connection, server connection, or other appropriate linking means. In one embodiment, the party can then select a time on the electronic schedule or send a communication identifying a time to which a replacement is required. The method can further include the steps of filtering all parties to select one or more parties with the appropriate characteristics to be a replacement for the selected time, accessing stored contact and scheduling information for all identified parties, and sending an electronic communication to identified parties inquiring as to those parties' interest in filling in for the selected time. The method can further include the steps of collating responses from all electronic communications, selecting a party out of responses to replace the requesting parties time, updating the electronic schedule, and sending notification to all parties as to the completion of the replacement.

In one embodiment, an approval from a manager, supervisor, or system administrator, may be required for a replacement to be accepted. The method can further include the step of communicating one or more notifications.

Another aspect of the invention can include a method for using electronic communications to exchange one worker's scheduled time with another worker's scheduled time. The method can include the steps of receiving an electronic communication from one or more parties, either directly through an electronic communication and/or through the party logging into a scheduling application. The method can further include the steps of selecting a time on the electronic schedule or sending a communication identifying a time for which a trade is required, selecting a time or date or other party with which the trade should take place, and, if more than one party or time is an option, filtering those to arrive at one or more party with the appropriate characteristics for a trade. The method can further include the steps of accessing stored contact and scheduling information for identified parties, sending an electronic communication to identified parties inquiring as to those parties' interest in trading for the selected time, collating responses from all electronic communications, selecting a party out of responses to make the trade, updating the electronic schedule, and sending one or more notifications to one, some, or all parties of the completion of the trade. In one embodiment, an approval from a manager, supervisor, or system administrator, may be required for an exchange to be accepted. The method can further include the step of communicating one or more notifications.

Another aspect of the invention can include a method for using electronic communications in conjunction with an electronic scheduling application or services, and/or manual data inputs, to accumulate information about scheduled parties performance. The method can include the steps of tracking a third party entered schedule time request for coverage to an electronic calendar directly or through communication mechanisms, such as, but not limited to SMS message, instant message, or email, when a start time that has passed and ascribing a negative metric to the party responsible for filling the scheduled time. The method can further include the step of tracking a manual input by a third party to an electronic calendar, directly or through communication mechanisms like SMS, for a worker's late arrival to a start time and ascribing a negative metric to the tardy party. The method can further include the steps of tracking a coverage event within given parameters (for example, after a scheduled time event has started or some period of time before a scheduled time event) and ascribing a positive metric to the party providing coverage. This performance data can then be correlated to create a performance measure or performance metric for each party associated with a scheduling application.

In one embodiment, a manager can manually input a tardy metric or a non-complete metric for a worker through a web connection, SMS text message, or other appropriate electronic communication.

Another aspect of the invention can include a method for using performance ranking for individual workers to create a schedule to reward better performing parties. The method can include the steps of accessing stored performance information for parties related to a given schedule, ranking the parties by performance information relative to each other, and presenting more than one party in ranking order around performance metrics for selection for times while scheduling.

Another aspect of the invention can include a method for parties to track multiple schedules, both related and unrelated, in various views in a single location, electronic calendar or application.

Another aspect of the invention can include a method for using electronic communications between remote workers of one or more work sites to cover other worker scheduled events at one or more different work sites. This can, for example, allow cross-pollination between stores for coverage or swaps using one or more means of electronic communication.

Another aspect of the invention can include a method for using various communication modes simultaneously to reach one or more workers associated with a scheduling or rescheduling request. This can include the formalized broadcast via multiple communication modes rather than other methods (e.g. an individual phone call) as a means to more efficiently enable coverage or swaps/trades.

Another aspect of the invention can include one or more means of improving the automation of a scheduling application. This can include collecting data and business intelligence to develop heuristics for modeling scheduling and rescheduling. In one embodiment, this can, over time, allow the scheduling and rescheduling function to learn from patterns of use of a scheduling application and increase and/or improve one or more automated steps in the scheduling application. This can for example, allow manual scheduling or complete automatic scheduling or a combination of both (input some shifts manually and complete the rest automatically).

Another aspect of the invention can include a method for creating a schedule comprising of combination of steps with manual and automated inputs.

These and other objects, along with advantages and features of the present invention herein disclosed, will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is a block diagram showing one configuration of a scheduling application, in accordance with one embodiment of the invention;

FIG. 2 is a block diagram showing one configuration of a profile set-up function for a scheduling application, in accordance with one embodiment of the invention;

FIG. 3 is a block diagram showing one configuration of a schedule creation function for a scheduling application, in accordance with one embodiment of the invention;

FIG. 4 is a block diagram showing one configuration of a communicate schedule function for a scheduling application, in accordance with one embodiment of the invention;

FIG. 5 is a schematic view of an empty schedule template, in accordance with one embodiment of the invention;

FIG. 6 is a schematic view of the template of FIG. 5, with the scheduling information completed;

FIG. 7 is a schematic view of an example profile template, in accordance with one embodiment of the invention;

FIG. 8 is a schematic view of an additional example profile template, in accordance with one embodiment of the invention;

FIG. 9 is a block diagram showing another configuration of a scheduling application, in accordance with one embodiment of the invention;

FIG. 10 is a block diagram showing an example notification function for one configuration of a scheduling application, in accordance with one embodiment of the invention;

FIG. 11 is a block diagram showing an alternative notification process for one configuration of a scheduling application, in accordance with one embodiment of the invention;

FIG. 12 is a block diagram showing a user update process for one configuration of a scheduling application, in accordance with one embodiment of the invention;

FIG. 13 is a block diagram showing an alternative configuration of a scheduling application, in accordance with one embodiment of the invention;

FIG. 14A is a schematic view of a completed group schedule template, in accordance with one embodiment of the invention;

FIG. 14B is a schematic view of an individualized schedule template, in accordance with one embodiment of the invention;

FIG. 14C is a schematic view of an alternative completed group schedule template, in accordance with one embodiment of the invention;

FIG. 15 is a block diagram showing one configuration of a schedule creation function for a scheduling application, in accordance with one embodiment of the invention;

FIG. 16 is a block diagram showing one configuration of a communication of a rescheduling function for a scheduling application, in accordance with one embodiment of the invention; and

FIG. 17 is a block diagram showing another configuration of a communication of a rescheduling function for a scheduling application, in accordance with one embodiment of the invention.

### DETAILED DESCRIPTION

The purpose of the current invention is to generate and manage a scheduling tool that can communicate with, and receive information from, users though SMS (Short Message Service) messaging and other related communication methods. SMS messaging provides a means of communicating with remote user though a short text message (such as, but not limited to, a message of no longer that 160 alpha-numeric characters) sent to a mobile device such as a mobile phone, PDA, PC, or other appropriate mobile device with a means of receiving and sending analog or digital messages. By utilizing SMS messaging within a scheduling application, a schedule manager can communicate easily with multiple users remotely, allowing an event or multiple events to be scheduled, organized, updated, and confirmed easily and quickly though a standard mobile phone.

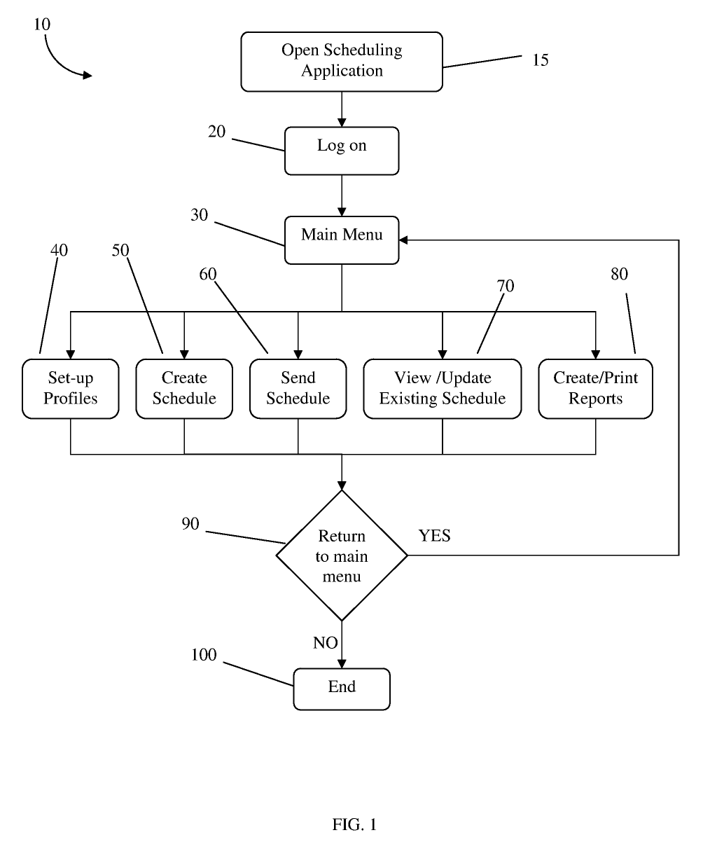

FIG. 1 shows a block diagram for one embodiment of a scheduling application. The application can function as a computer program stored in a PC or as a web-based program, allowing information to be generated, communicated, and stored in any appropriate format, and allowing access from any appropriate device with access to a communications network, such as the internet. The scheduling application can then be entered by either linking to it through a web page or loading a program that has been pre-installed on a PC or other appropriate device.

The block diagram of FIG. 1 shows a scheduling application 10 with multiple functions. Once the scheduling application 10, or a portal to an access screen for the scheduling application, has been opened 15, a user is prompted to log on 20 to the application 10. Upon logging on 20, a main menu function 30 is entered. From this main menu 30, a number of functions can be entered. These functions include a profile set up function 40, a schedule create function 50, a schedule send function 60, a view and/or update existing schedule function 70, and a create and/or print reports based on scheduling information and/or profile information function 80. Once a function has been completed, a user can choose to return 90 to the main menu 30 or exit 100 the application 10. In should be noted that in an alternative embodiment, not all functions are required for a given scheduling application 10, but rather any combination and arrangement of these functions may be used, based on the requirements of a user and/or scheduler. In a further alternative embodiment, some of these functions, such as the create schedule function 50 and send schedule function 60, can be combined, such that, for example, a schedule is automatically sent once it has been created without having to return to a main menu 30 between steps. In a still further embodiment, no main menu function 30 is required, but rather the scheduling application 10 can open one or more profile 40 or scheduling functions 50 immediately upon opening the application 10.

Once the application 10 has been opened, a prompt may ask for a login name and/or password to be entered. This function can ensure that only authorized users can enter the scheduling application 10, and allow the application 10 to customize functions and user profiles for each individual. For example, a separate user profile and personal schedule can be created for each user, such that logging on 20 to the application 10 with a username and/or password allows access to the specific users' information alone. Different levels of administration permission can also be assigned to different log on information, such that only certain users have the ability to access certain functionalities of the scheduling application 10, or access and amend multiple user profiles. In an alternative embodiment, a user my not be required to log on to enter the application 10.

Once a user has logged in 20 to the scheduling application 10, a number of functions may be performed. For example, an individual users profile can be created 40 or updated to provide additional or updated information for the scheduling application 10 and other users. This profile information can include contact information, such as, but not limited to, mobile phone numbers, email addresses, Instant Messaging (IM) contacts, fax numbers, or other appropriate contact information which may or may not include a security block for certain users (as described below). A personal schedule can also be created and/or updated, storing information on the availability of a user over a certain time period, such as, for example, a day, week, month, or year. Once this information has been stored within the scheduling application 10, it can be accessed by schedulers and/or other users when scheduling an event or meeting that is to include that individual user.

The profile information for each user can be stored and grouped in a number of ways. For example, a master profile list can include every profile within the system, while further profile groups can include different subsets of the master profile. This can be of particular importance for company structures, where profiles can be grouped by department, seniority, job title, years of service, or other appropriate grouping. This can, for example, allow a user to create a schedule quickly for a specific department, without needing to look through the entire master profile list for the relevant profiles. Other users of this application 10 can include, but are not limited to, clubs, non-profit organizations, sports teams, and groups of friends and/or family.

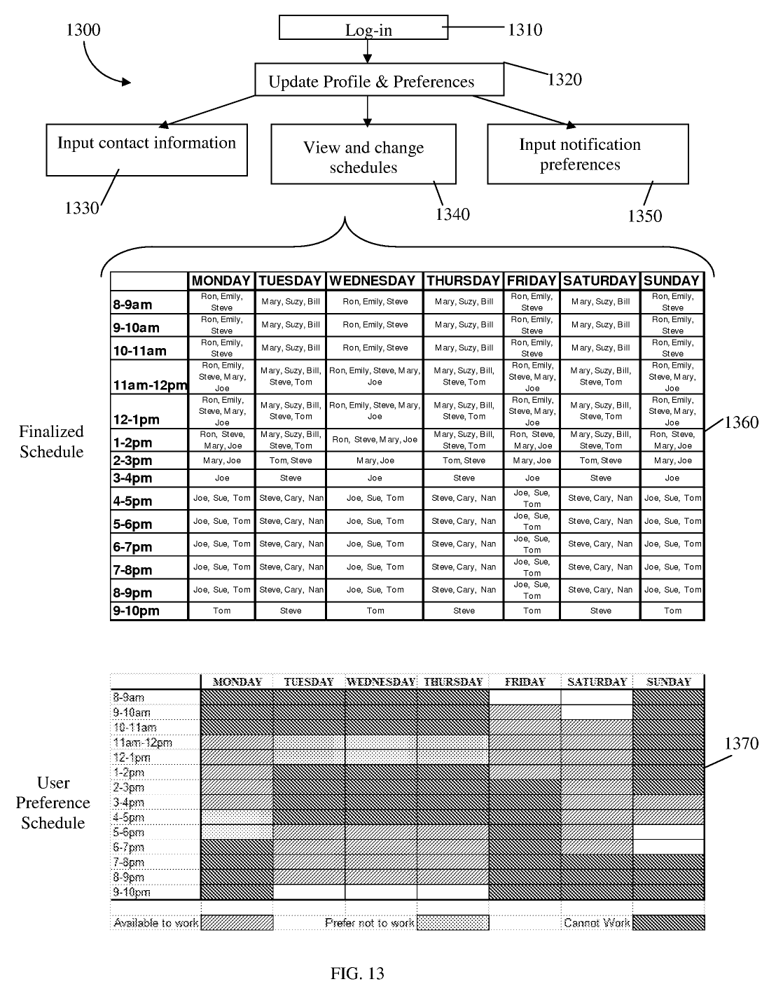

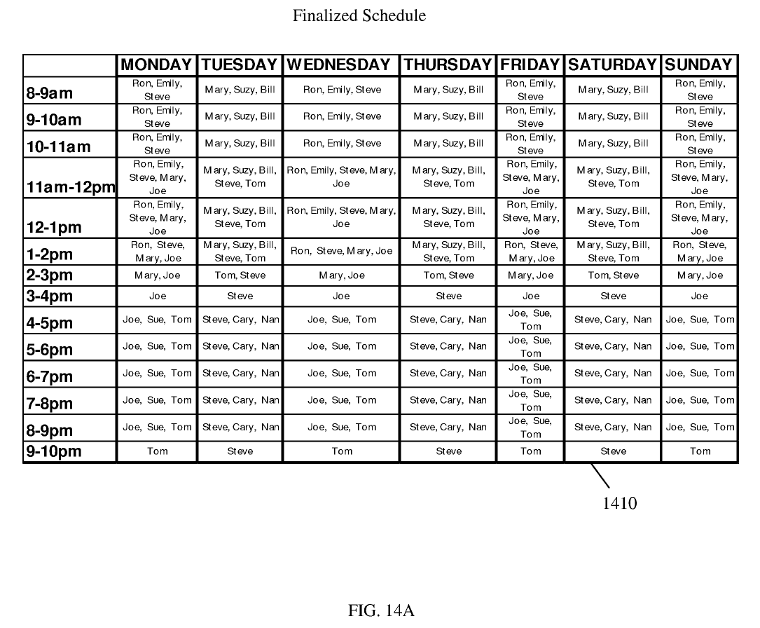

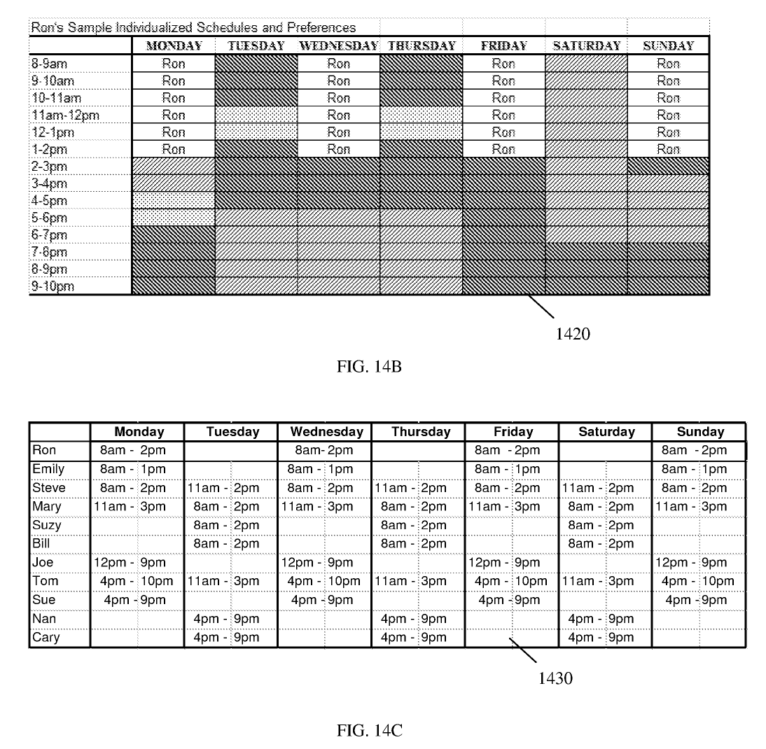

Once profile information is stored in the scheduling application 10, the user is free to create scheduling events 50 for any group of users with stored profiles, or a subset thereof. A user is also free to send scheduling 60 and/or other information to selected users, generate reports 80 based on stored scheduling information, and view and update previously stored profiles 70 and schedules. In an alternate embodiment, reports may be printed in a different format than is presented electronically. Example formats can be seen in FIGS. 13-14C.

In one embodiment of the invention, the user preference schedule might also reflect an individual users' finalized schedule. Both the finalized schedule with all users and/or the finalized individual user schedule may be printed out in a different format, as illustrated in the example schedule formats shown in FIGS. 14A, 14B, and 14C.

Reports may be created automatically once a scheduling event has been created and confirmed, or alternatively or additionally be generated upon a specific request from a user. Report information can include profile information from all users on the master profile list, or a select subset of those users. Report information can also include specific schedule information for a single user or group of users. Report information can also capture various changes to a finalized schedule throughout the scheduling period. Further reports can, in some embodiments, generate information related to specific group schedules, such as times and lists of attendees, list of non-responders, etc. In an alternative embodiment, the scheduling application may include a searchable database functionality, allowing a user to generate and print a report based on any specific profile or schedule information stored within the application 10.

In one example embodiment, reports associated with a specific schedule can be generated from a link within a user profile or within a create and/or view schedule function. Alternatively or additionally, reports can be created and printed out from a separate report creating function that can be accessed from the main menu 30 of the scheduling application 10. The scheduling application 10 can also be configured, in one embodiment, to automatically, or through a user request, send a report to all users selected for a specific event, or to certain select personnel within the user profile database. These reports can, in certain embodiments, be customized such that each user only receives information that she is authorized to receive. This can either be automatically configured or selected by a user creating a schedule.

The scheduling application 10 can also include different levels of automation. For example, one user creating a schedule (i.e. a scheduler) may want to be prompted for a user input before certain actions are carried out, such as, but not limited to, updating and sending out a new schedule based on user responses to the original request. However, another user may want those actions to be carried out automatically by the scheduling application 10 without further user input being required. These functions can, in certain embodiments, be included within the scheduling application 10 to allow a user to create a schedule based on the level of automation preferred by that user.

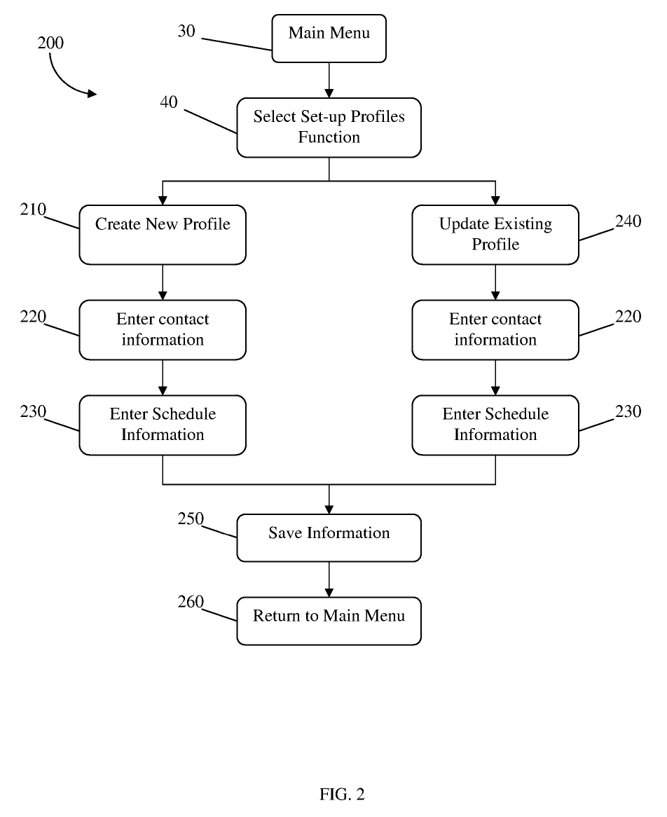

A block diagram showing a profile set up function is shown in FIG. 2. In this embodiment 200, a profile set up function 40 can be selected from the main menu 30 of the application 10. Within the profile set up function 40 a user, or scheduler, can create a new profile 210 or update an existing profile 240. In each case, the user can enter new contact information 220 for that user, and/or enter new information related to the users' schedule 230. Alternatively, the scheduler may require a user to complete contact information via the user's initial log-in process. Once the information has been entered, it can be saved and stored 250 within the scheduling application 10 for use in generating a schedule for a group of users. Once the information is stored 250, the user can return 260 to the main menu 30.

A user profile may encompass a number of separate pieces of information. This can include a cell phone number, allowing the scheduling application to send SMS messages to each user, and/or other communication addresses such as, but not limited to, an email address, a fax number, an IM number, an individualizable web browser page, a home or office phone number, or a pager. A user profile can also include other information related to an individual user. For example, within a scheduling application for a business, a user profile can include, but is not limited to, the users department, job title, place of work, locations where the user could attend meetings, and alternative staff that can attend a meeting in place of the user.

A user can also create an individual schedule to be stored within the scheduling application 10. This schedule can be entered into a generic schedule template stored within the scheduling application, or be customized to create a specific template appropriate for an individual user. In one embodiment, a scheduling application 10 may include a number of generic templates from which a user can choose. Once an individual user template has been chosen, scheduling information for that user can be input and stored within the scheduling application 10. This information can include, but is not limited to, when the user is available to work or attend a meeting, when the user could work or attend a meeting but would prefer not to, and when a user is not available. Further information, such as, but not limited to, holiday schedules, specific locations where a user will be at certain times or on certain days, or specific tasks a user is attending to at certain times or on certain days, can also be included within the scheduling information.

This information can be input into the template in any number of ways, including, but not limited to, typing information into each box on the template, dragging selected information into each box from a set list of functions, or selecting information from a drop down menu for each box.

Once the information has been input into the scheduling application 10 it can be stored 250 within the system so as to be available for any user wishing to create a scheduling event for a group of users. The contact information within each profile, such as the user's cell phone number, can then be used to send messages relating to a schedule to each user within a selected group.

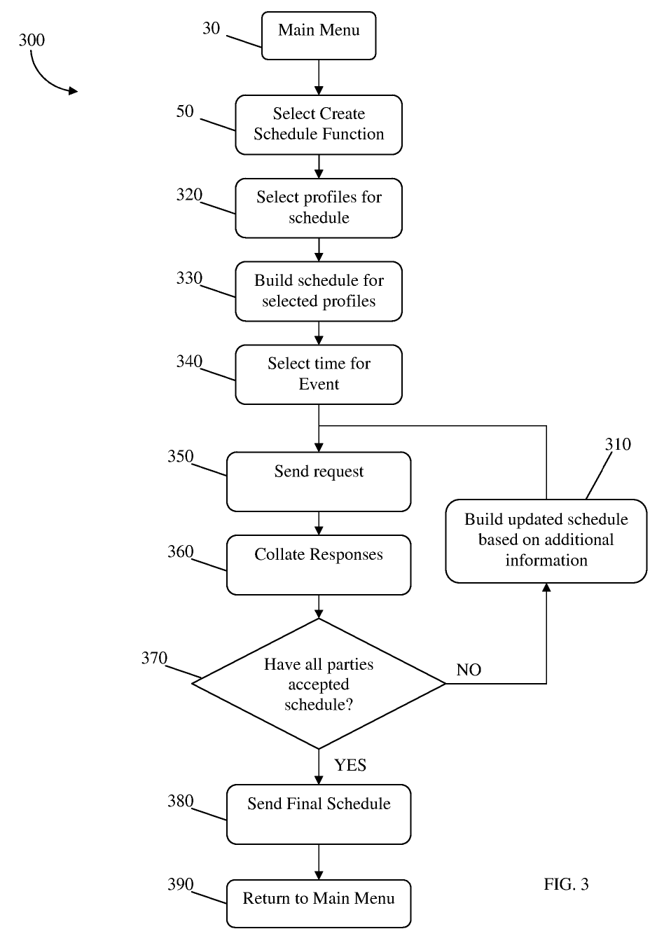

A block diagram showing a create schedule function is shown in FIG. 3. For this function 300, a create schedule function 50 can be selected from the main menu 30 of the scheduling application 10. Within this create schedule function 310, the group of users who are to attend the relevant event or meeting can be selected 320 from a master profile list. Once all the relevant parties have been selected 320, the scheduling application can collate the stored schedules 330 for each individual within the group and create a proposed schedule for the entire group. The template for this group schedule can be chosen from one or more generic templates stored within the scheduling application, or be created separately to produce a customized schedule for that group and/or event.

The proposed group schedule can show information such as times at which all users are available, when all users are not available, or show times at which only some users are available and which specific users (or how many users) are available at each time. From this, the time at which the event can be scheduled can be selected 340. This can be done automatically by the scheduling application, or be selected manually by the user creating the group schedule.

Once a time, or times, has been selected 340 for an event, or a series of work or meeting times within a finalized schedule, based on the available schedules for each individual user within the group, a message can be created with the relevant information and a request can be sent 350 to the interested parties. This request can include all the required information and instructions on how to respond to the request. In some embodiments of the application a greeting or other additional information may also be included in the request message. Further information that may, in some embodiments, be included within the request message include, but are not limited to, a quick link to a set up page, instructions on how to update a profile or individual schedule, or request for additional information.

Once the request has been sent 350 to the selected individuals that will make up the group, the scheduling application is ready to receive responses from each individual 360. These responses can take the form of a reply message sent from individual users and/or a response from a user that is input into the scheduling application from a remote site. For example, each party can reply to the request by return SMS message from their mobile phones with a simple acceptance or rejection of the proposed schedule. In one embodiment of the application, a user may reply with the message “Yes” or “Y” if the schedule is accepted, and “No” or “N” if the schedule is rejected. These simple responses can be received, collated, and interpreted by the scheduling application without the need for further user input.

Based on the responses from each member of the group, the scheduling application 10 can either confirm the schedule (if all parties have accepted the proposed schedule) or update the schedule (if one or more party has rejected the proposed schedule) 370. An updated schedule 310, based on the additional information, can be generated and a new request can be sent to the interested parties. This new request can include the message as before, but with new scheduling information, or be customized to provide more specific information to the interested parties.

Once a schedule has been accepted by all the interested parties 370 a confirmation message confirming the finalized schedule can be sent to the interested parties 380. The scheduling application 10 can also, in certain embodiment, be configured to send reminder messages to each member of the confirmed group at set times prior to each scheduled event. The scheduling application 10 may, at that point, return 390 to the main menu 30. In alternative embodiments, there is no need to return to the main menu 30 at the end of any one of the functions within the scheduling application 10, but rather the application 10 can be closed and allowed to run automatically, or be closed and opened at a later time to continue based on a user input.

In alternative embodiments the need for a confirmation or acceptance of the proposed time by user can be omitted. It can be assumed that by providing information about his or her availability, the user is willing to automatically accept a commitment at his or her available times, and the scheduler can therefore automatically include the user in a finalized schedule for an event. Thus, a user is merely notified of his commitment within the finalized schedule.

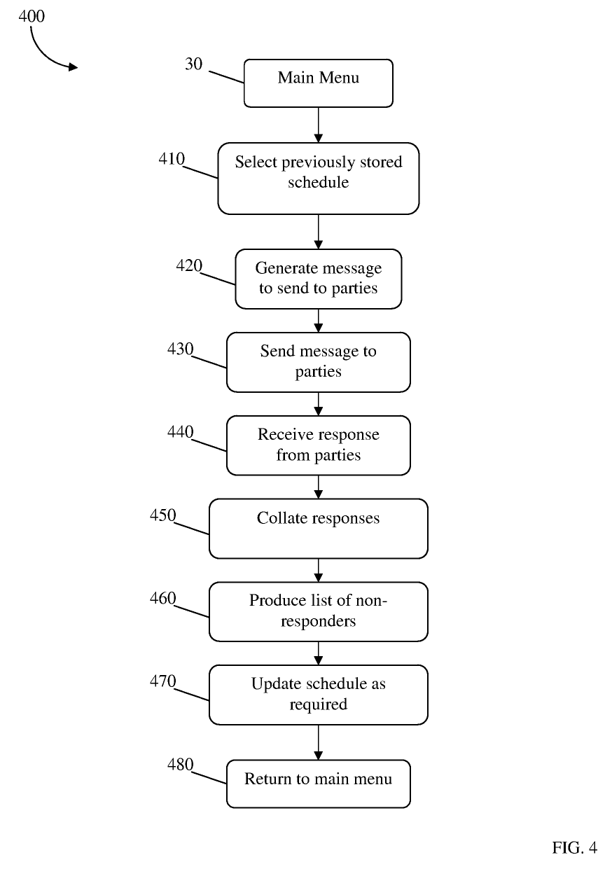

Rather than create a new schedule every time an event request is to be sent out, a previously stored schedule can be uploaded and sent out at any time. This can be advantageous when scheduling repeated events, such as a monthly meeting, or when scheduling an event for a standard group of users, such as a department of a company or the members of a club. This can also be advantageous when a user wants to create a schedule but not send it to the selected parties until a later time or date. A block diagram showing a send schedule function is shown in FIG. 4. This function 400 can be used to send a previously created and stored schedule, send a standard schedule that may be repeated at set time intervals (for example once a month), or send a newly created schedule.

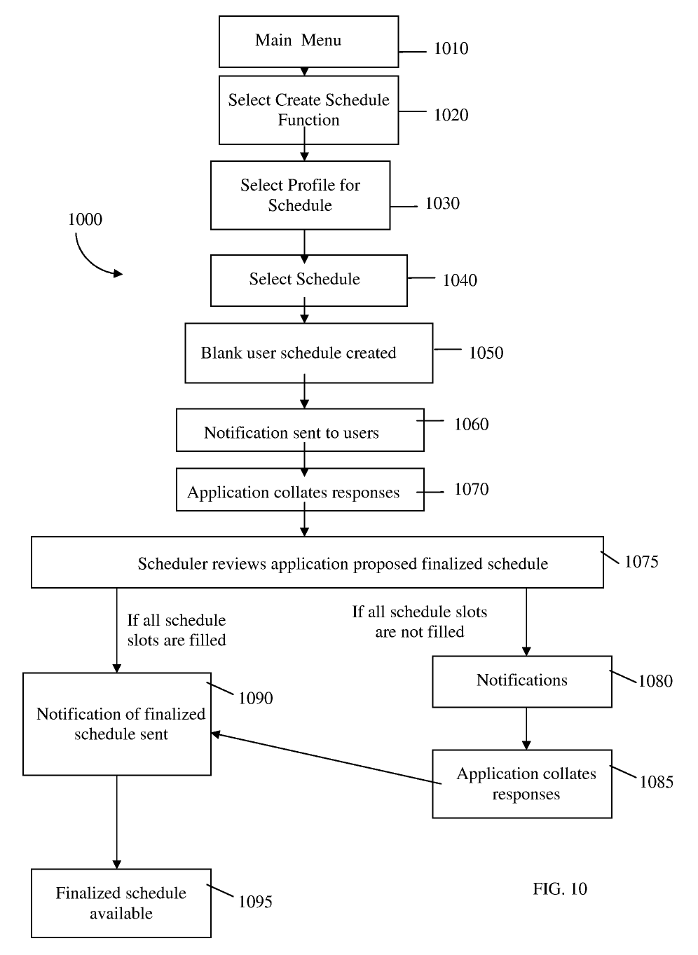

In this embodiment, a send schedule function 400 can be selected from the main menu 30. The previously stored schedule within the scheduling application can then be selected 410. This can for example include a set group who are to attend a pre-stored scheduling event (such as a monthly meeting) and/or selected individuals from a master profile list. Once the interested parties have been selected 410, a message can be generated 420 to send to the interested parties. This can be a generic, predefined message or a customized message for this individual scheduling event. For example, a user can select the information and generic greeting from a menu of options, or type in a greeting to go along with the required scheduling information created by the scheduling application 10. In an alternate embodiment, this message can be a notification (sent one or more times) to the users, indicating the date and time in which a finalized schedule will be created and requesting users to input information about their availability. An example of this notification is illustrated in FIG. 10.

Once a message has been created 420, it can be sent to the interested parties 430 using any of the communications means within the user profiles. For example, in one embodiment, the message is sent via SMS message, while in another embodiment the message can be sent by both SMS messaging and email. In an alternative embodiment, any additional or alternative means of analog or digital communication can be used.

Once the messages have been sent to the interested parties 430, the scheduling application 10 can wait to receive responses back from the parties 440. Once all, or a certain number, of these responses have been received back, or once a set time and/or date has passed, the scheduling application can collate the responses 450 and update or confirm the group schedule as required 470. A list of non-responders to the scheduling request can also be generated 460. At this time, a report summarizing the schedule, attendees, and non-responders can be generated and printed. In one embodiment, the scheduling application 10 can be set to automatically create a list of non-responders and update the proposed schedule based on the received responses after a set time period and/or after a set number of responses has been received. In an alternative embodiment, a user can set these parameters. The scheduling application 10 can also be set to automatically send reminders to any parties who haven't responded, or updated their availability on the web application, after a certain time. The scheduling application 10 may, at that point, return 480 to the main menu 30. An example notification embodiment is illustrated in FIG. 10.

In one embodiment of the invention, a user profile can include a link to other user profiles related to that user. For example, a member of a specific work group or project can be linked with the profiles of all other members of that group or project, such that all members of a group can be selected for a specific scheduling event from the profile of any one member of that group. This can happen automatically, or require a user input (such as selecting a specific option within a user interface). In an alternative embodiment, a user profile can include links to alternatives users that may replace that user if she/he is unavailable for a specific event either before or after a finalized schedule has been created (as discussed below). For example, a group manager may have a link to a specific member of that group, such that if the manager is unavailable for a meeting then a scheduling request is sent to her designated “second” within the group.

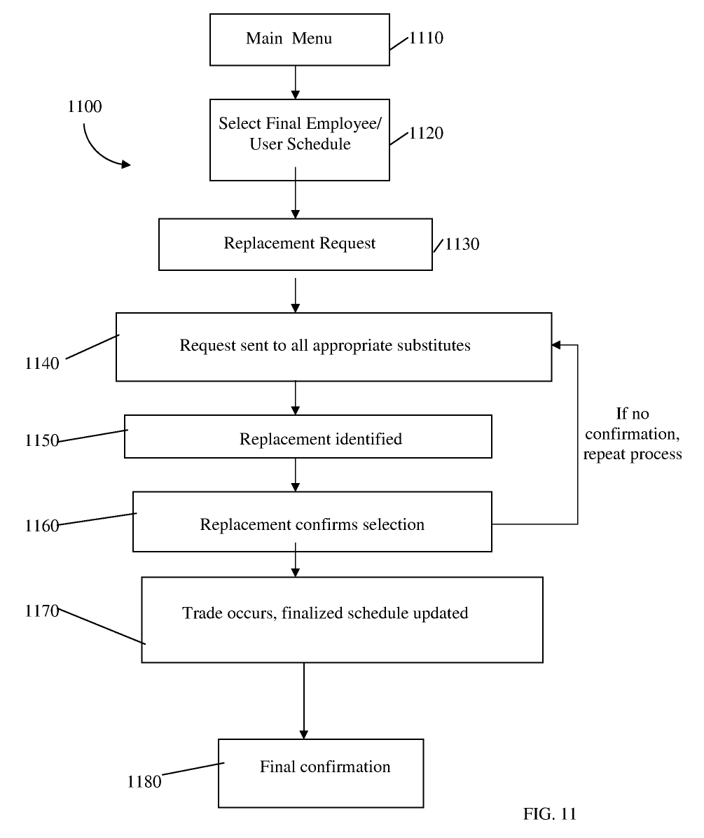

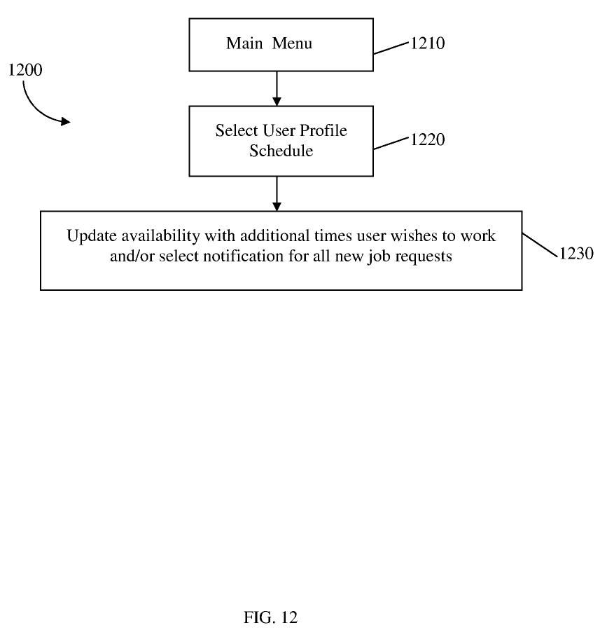

In one embodiment of the invention, illustrated in FIG. 11, a series of communications between a user and a potential substitute not only notifies of a specific event, but also goes through a series of confirmations to assure that the new user for an event within a finalized schedule is committed to that new event. This is described in greater detail below.

In alternative embodiments, links can be set up from a users profile to other people at the same geographical location (e.g. either working out at the same office, working at the same client, or scheduled to be in the same geographical area on a specific day). Further links can be set up from a specific user profile to that users assistant, secretary, or manager, such that in the event that a user does not respond to a scheduling request, for example, related parties can be made aware of the problem. Alternatively, a preferred alternative communication method (such as email or IM) may be linked to the profile such that a scheduling request can automatically emailed to a users email account, for example, if that user does not respond to an SMS message by a certain time, the time limit being either automatically set or based on a user selection. Alternatively, a user may receive copies of the same information communicated via one or more modes of communication.

A user profile can, in one embodiment, be set up to include additional information that may be relevant when scheduling an event. This information may include any number of additional pieces of information including, but not limited to, preferred meeting locations, language skills, dress code, other expertise, and/or special needs (such as physical handicaps or special dietary needs).

In one embodiment of the invention, pricing and/or billing information can be included in a user profile. This information can, for example include the cost of sending an SMS message to a specific user (which may for example be dependent upon the cell phone network to which the user subscribes) or receiving a message back from a user. Billing information can also include estimated billing expenses associated with the time required to set up a schedule, or set billing expenses that may be incurred by requesting a specific user to attend a scheduled event (such as, for example, billing rates that a contractor may charge to attend a meeting). Possible overtime requirements or other costs associated with a certain scheduling event can also be included. For example, in a retail application, a scheduler might have a target expense number that needs to be achieved, so the schedule needs to strike the right balance of workers within a salary level.

Further information can also be included within the scheduling application, or within a specific user profile. This information can include, but is not limited to, what particular language should be included with a particular SMS message and what level of instructions needs to be included with a specific request (and possibly how many times a specific instruction need be added when sending a request to a specific user). For example, the scheduling application can be set up such that instructions on how to respond to a request are included for a set number of times that a request is sent to a certain user. After the user has received the set number of requests, these instructions need no longer be sent, as it can be assumed that the user now knows how to respond without the need for instructions. Alternatively, in seasonal events (such as summer jobs or holiday gatherings) that may occur infrequently, the application may, after a lapse of time with a user, restart whatever level of instructions are deemed appropriate.

The amount of hours a specific user can work in a given week can also be stored within a profile. For example, if a worker is required to work 35 hours a week, the percentage of time still available within that 35 hours can be calculated for a specific week. Security clearance and other limitations on information that a user can receive may also be included in a user profile.

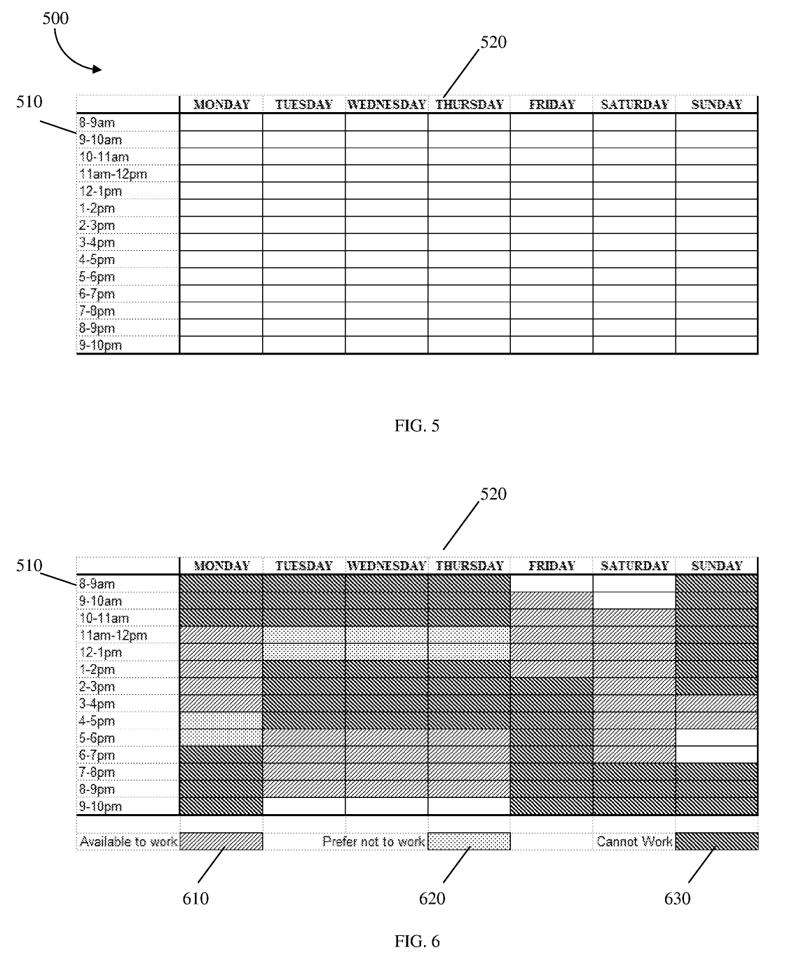

An example template for use with the scheduling application can be seen in FIG. 5. This template 500 includes a left hand column 510 indicating the time periods at which events may be scheduled. The remaining columns 520 correspond to the seven days of the week. In this embodiment, the left hand column 510 of the scheduling template indicates one hour time intervals from 8 am to 10 pm. In alternative embodiments of the invention, these time periods may be of any length, and may either be of a single set length of be of variable or differing lengths, depending upon the requirements of the user. In alternative embodiments, the time scale over which the schedule spans may also be of a different length. For example, a template can be configured to span a full 24 hour period, or be configured to span a shorter working day, such as, for example, from 9 am-5 pm. In a further alternative embodiment the scheduling template 500 can be configured to provide different time intervals and/or different time spans on different days of the week. The scheduling template 500 can also be configured to span a larger or smaller number of days, such as, but not limited to, spanning a single Monday to Friday time period, spanning a two week time period, or spanning a full month.

In one embodiment of the invention, different schedule templates can be provided for different events, such that a different scheduling calendar can be selected depending on whether the event is, for example, a meeting, a conference, a meal, a group activity, or another event.

An example scheduling template including stored data for a single user can be seen in FIG. 6. Here, the scheduling template 500 has been configured to provide color coded information relating to the availability of a particular user at a given time within the schedule. Here, three separate colors are used to indicate whether the user is available to work 610, would prefer not to work 620, or cannot work 630. By viewing this information, the user's availability at any given time can be ascertained. In alternative embodiments, other means of indicating whether a user is available at a certain time can be utilized. These means may include, but are not limited to, text, other visual indicators, and/or audio indicators. In one embodiment, the information may be stored digitally to allow the scheduling application to quickly and automatically read and update the information as required. In an alternative embodiment, other appropriate storage means are envisioned. The frequency with which a given user can update their availability for additional given time within a schedule is illustrated, in on example embodiment, in FIG. 13, where a given user can see both their finalized schedule (in white) as well as their availability for future scheduling.

By combining the completed scheduling templates for a number of users, a master scheduling template can be created; indicating times at which all, or a subset of, the selected users may be available, or not available. This master template can then be used, for example, to schedule a meeting or other specific work or leisure event. For example, in one embodiment of the invention a user can select a group of profiles from a master profile list incorporating a group of users, such as a company employee list, or a department list within a company. Upon selecting the profiles of interest, a scheduling template can be automatically generated that encompasses all the individual user templates (such as the individual user template shown in FIG. 6). This master template can then be used to choose a suitable time (either automatically or through a user input) to schedule an event. This proposed scheduled event can then be sent as an SMS message to the proposed participants through the contact information within the user profiles. Responses to this message can then be used to either update or confirm the time for the scheduled event.

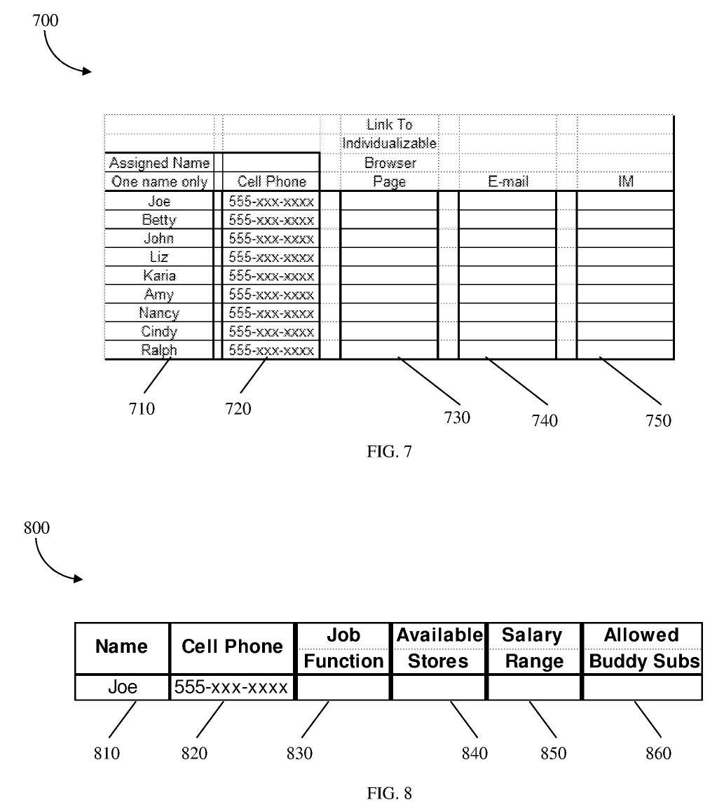

An example master profile list can be seen in FIG. 7. This list 700 can include as the left hand column 710 the names of all people within a group, such as a company, department, or team. The master profile list also includes a number of means of communicating with the people within the group. Here, a list of cell phone numbers 720, web browser pages 730, e-mail addresses 740 and instant messenger addresses 750 are included for each group member. In an alternative embodiment, additional or different information, including, but not limited to, fax numbers, and home or office phone numbers, can also be included within each user profile.

This master profile list can be used to choose a group of people for whom a scheduling event is required. This group may consist of everybody within one profile list, of a subset of people within that profile list. The means by which scheduling information is to be shared within the group can also be chosen, by for example selecting one of more columns within the list of possible communication means. In an alternate embodiment, the application may automatically select the list to which to distribute information about the event. For example in a retail application if a user is unavailable for a prior committed work event, that user may ask the application to select appropriate other users within the same profile and send a request via SMS text message, or other communication means, requesting a substitute. In FIG. 7, the names of everybody within the profile list have been chosen 710, along with the cell phone numbers 720 for this group. As a result, once a schedule and/or proposed event has been created for the group, a message can be sent to the selected users by SMS to the users cell phones.

Further information can also be stored within the profiles of the members of a group list. FIG. 8 shows an example profile 800 for a single user 810 including a cell phone number 820 along with the user's job function 830, and other work related information. In this case additional columns include the stores at which the selected user is available to attend 840, the users salary range 850, and the list of allowed substitutes 860 for that specific user if he cannot attend a scheduled event. This information can be included in a single table along with the users full contact information, or be listed in a separate window that can be accessed by, for example, single or double clicking on the name of the user of interest.

In alternative embodiments, any combination of information related to a specific user can be included in a single profile list, depending upon the requirements of a user. This information can be made available to all users, or certain information can be restricted so as to be made available to only a limited number of users, such as a group manager and/or administrator. The scheduling application can be arranged to provide a number of groups of information, such as, but not limited to, those shown in FIGS. 7 and 8, such that the relevant information can be quickly and easily obtained for a given user, or application, depending upon the requirements of the person scheduling the event or on the event itself.

In one example embodiment of the invention, the scheduling application can provide one or more employers/schedulers with a means of checking availability and scheduling staff or contract workers/users for a given time period. In this embodiment, the scheduling application can include a database of individuals that wish to indicate that they are available to work at certain times over a set period. The prospective employer can then select a time at which they require a worker, or workers, and have the scheduling application find and select workers available at that time and send out a request to those individuals.

In this embodiment, any individual wanting to indicate their availability for work can create a profile in the scheduling application and complete a personal calendar indicating times that they are available for work, or other activities. The profile can also include further information including, but not limited to, the geographical area that the individual is able to work, the type of jobs the individual is willing to perform, a resume and/or qualifications, and the minimum wage the individual is willing to work for. The profile should also include contact information, such as a cell phone number, email address, and/or IM address. The individual may also be able to set up a number of different calendars, or a number of different preferences within one calendar, so that they can limit the type of work or activity, and/or location of work, that they are available for at different times. The availability calendar of the individual can then be added to a master scheduling calendar stored within the scheduling application.

The overall master scheduling calendar can, for example, combine the availability information for all users in the system. This information can include, but is not limited to, the time, location, skills, pay requirements and/or any other appropriate information entered by the users. A scheduler can enter a scheduling request into the application, which can then search the master scheduling calendar for any users who are available at the requested time, or times, and meet any other requirements the scheduler may have. Further master schedule calendars, relating only to subsets of the fully available information (e.g. limiting the information to one or more geographical location, job function, employer, pay scale, or other appropriate group) can also be provided.

An employer requiring a worker, or workers, at a given time can log on to the scheduling application and select a time period that that employer requires workers. The prospective employer may, in some embodiments, also select job description, pay scale, location, and other appropriate information that could be helpful in assigning appropriate workers to a specific job. Upon entering the information, the scheduling application can search the database for any individuals that are available at the selected time period, and meet the employer's preferences or requirements.

The scheduling application can then send a text message, and possibly also an email and/or IM message, to the available individuals to check if they wish to accept the work. The text message can include information such as, but not limited to, the time of work, the place of work, the type of work, and the pay scale. The message can then prompt a simple YES/NO (or “Y/N”) response to the request. In alternative embodiments, longer responses including different and/or more information may be asked for. Each individual can then accept or refuse the work offer by return text message, or alternatively by logging on to the scheduling application and responding through a link in the application.

Notifications serve an important function within the application. Since many of the potential users may or may not maintain a formal calendar, it is important for a scheduler who is creating a finalized schedule coordinating multiple users to have the ability to notify and remind users of the time and date in which a given event schedule will be finalized. For example, this may be particularly important in a retail application, where employee or user coverage of a store during store hours is a requirement. In such an application, the ability of an employee or user to provide preferred work hours for input into a finalized schedule is important in being able to create a finalized schedule that does not require additional changes. Thus, an employer or scheduler may issue a series of reminders as to the date and time in which a schedule will be finalized, followed by a notification once the schedule is finalized. This is illustrated, for one example embodiment, in FIG. 10.

In one embodiment, the prospective employer can be given a list of individuals who are available to work. This list can include any variety of information, such as, but not limited to, the users name, nickname, resume, qualifications, and experience. The employer can then choose from this list which person, or people, she wishes to employ at the selected time. The profile information available for viewing by a prospective employer may be selected by the individual user, with all other information in the individual's profile being hidden.

In an alternative embodiment, a request can be sent out by the scheduling application automatically to all available workers, or to a group selected from the pool of available workers based on set criteria, without the need for further input from the prospective employer. For example, if an employer only requires one individual at a certain time, the scheduling application may automatically send a request to the most experienced or qualified individual within the group of available workers, and only send out requests to another individual if the first person on the list replies “NO,” or fails to reply within a certain time period.

In one embodiment of the invention, an individual can control the security of their profile information by limiting the profile information an employer, or other user, can view. Here, a user can control the profile information that is made available to other users when creating or updated their profile. For example, a user can choose not to allow another user to view any contact information, so that while the scheduling program may contact the user directly if a scheduling request is made, the prospective employer, or other user, cannot gain access to that contact information (e.g. full name, e-mail address, cell phone number, IM address and others). In one embodiment, the individual can set different preference settings for different employers, groups of employers, and/or individual users, such that different individuals or employers are allowed access to different subsets of information within an individual's profile. As such, any employer looking for possible workers will only be allowed access to profile information that each individual has designated as viewable. Thus, an individual can set different security levels for their stored information based on their own preferences. In an alternative embodiment, the scheduling application can restrict all employers or users to limited or no profile information, with the profile information only being used by the scheduling application itself to check on the availability and status of each individual.

In one embodiment, once the required number of individuals have accepted the proposed work, a confirmation message may be sent to the employer, and/or prospective workers, that the employment schedule has been completed and the work has been assigned. At this time the scheduling application can automatically update the calendars of each individual to indicate that they are no longer available. Alternatively, an individual could trade work or pass work on to another user within the database directly. FIG. 11 shows one embodiment of a notification process in which a job event is traded.

Alternatively, an individual can choose not to have the scheduling application update their availability, so that they can still receive information on other work opportunities at that time. In this embodiment, if a higher paying job or more attractive job is available at the scheduled time, an individual can choose to select the other job instead of the previously accepted work, at which time the scheduling application would have to send out further requests to fill the prior job that the individual had chosen. Additionally, after accepting a job, an individual may later find that they will not be available for that job for personal or other reason. In this situation, the individual may again cancel their acceptance, at which time the scheduling application will have to send out a further request for that work.

The scheduling application can, in some embodiments, allow each individual to log in to the application through the web at any time using a PC, laptop, PDA, mobile phone, or other appropriate means. As a result, users can constantly update their scheduling calendar and profile so as to make themselves available for work, or cancel their availability, at short notice. Individuals can also monitor their schedules at any time through the scheduling application, and change their profile as required. In one embodiment, once a task has been accepted, the scheduling application can send out one or more reminder text messages, and/or email and IM messages, to the individual, confirming the time and location of tasks that the individual has accepted.

In an alternative embodiment, an individual can use their cell phone to update their availability on the scheduling calendar. This may be achieved by either sending messages through SMS to a given number linked to the scheduling application, or by calling a given number and using a touch tone phone to update a schedule based on choices from menus of options.

In one embodiment of the invention, an employer may be able to post reviews or grades for an individual, such that future employers can evaluate whether they wish to use that individual or not. In one embodiment this grade can include, for example, a mark out of ten or a written review. In certain embodiments, this information can automatically be made available to prospective employers, while in other embodiments an individual can choose whether to make this information available to prospective employers. Thus, employers can rate individuals based on performance, reliability (such as whether they show up for work that they have accepted), or other appropriate characteristic, so that they have some level of quality control over the people the hire for each upcoming task.

The above-mentioned application can be of great use to students and other people with flexible schedules, who wish to be available for employment at short notice and at varying times. Employers, such as retail employers, catering companies, charities, and other companies who may have additional temporary staffing requirements at short notice, can use the scheduling application to quickly obtain short term staffing through a centralized source, by simply setting the time and location that the workers are required, and allowing the scheduling application to send requests and receive acceptances or rejections based on a database of individual scheduling calendars that the prospective workers can update remotely, and quickly, at any time.

By allowing individual users to constantly update their profiles and calendars, and set security blocks and preferences as required, the scheduling application can quickly find willing and available workers for a given employer with minimum effort on the part of the employer, and minimum intrusion on the privacy of the individual users. As described above, the scheduling application can also by of great use in leisure activities, such as meeting with friends or participating in club activities. By allowing a user to set up different calendars, or different preferences within one calendar, users can make themselves available for leisure and/or work activities at any time, and allow their calendar to be quickly updated based on any scheduling requests received.

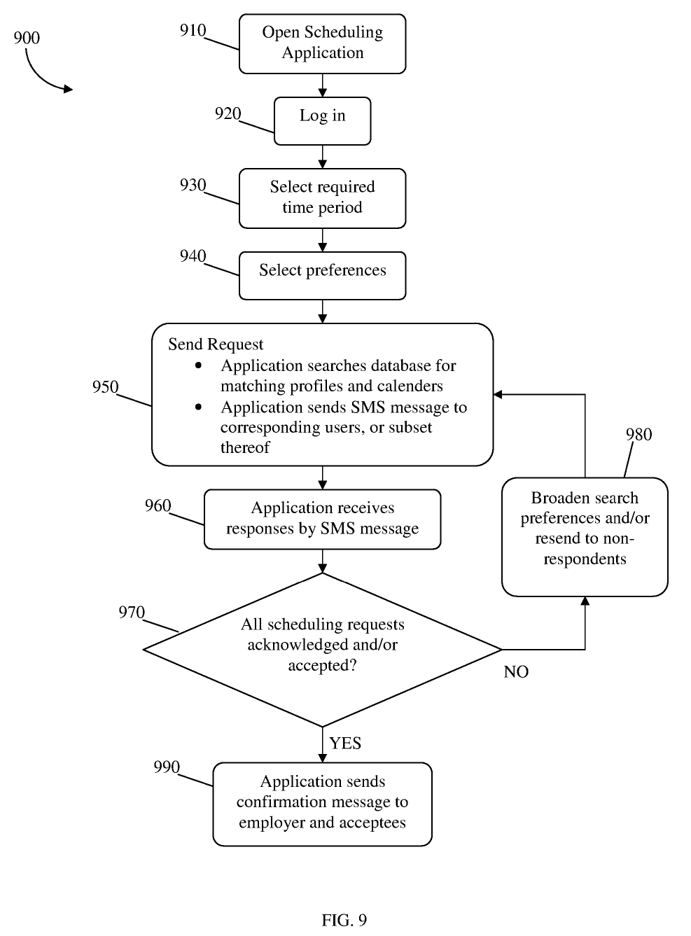

A further example method of implementing a scheduling application can be seen in FIG. 9. In FIG. 9, a scheduling application 900 can allow an employer, recruiter, club, or individual to search for workers to attend a specific event. Here, an employer can open 910 the scheduling application 900 through a web link or through a program installed in a PC, laptop, PDA, or other appropriate device. After logging in 920, the employer can select a time period 930 at which they wish to request workers or volunteers. The employer can then select preferences 940 to narrow the search for available workers. These preferences can include, but are not limited to, the location of the work, the number of required workers (any number greater than or equal to one), the work experience required, the qualifications required, the skills required, the pay scale for the work, or any other appropriate requirement.

Once the employer has selected the time period 930, and selected the preferences 940, the request can be downloaded into the scheduling application 900 in order to send out requests 950. Here, the scheduling application 900 will search the database for all users who have indicated that they are available at the required time, and who meet and specific preferences requested by the employer. Once a list of available users has been compiled, the scheduling application 900 can then send an SMS message to this list 950, or a subset thereof, to ask if they wish to accept the requested work. This request can be sent automatically, or by prompting the employer to select users from the list to send the request to.

In one embodiment, the scheduling application 900 can send out a request to all users on the compiled list of available users, with the scheduled work being filled on a first to reply basis. Once enough people have accepted the work, the scheduling application 900 may send an SMS message to all other people on the list to tell them that the job has been filled or the finalized schedule has been changed. In one embodiment on the invention, the scheduling application 900 can store the names of anyone on the list who “accepted” after all the available jobs had already been filled as a set of alternatives, so if any users who had previously accepted cancel at a later time, these alternatives can be requested to accept the now available work.

Once the requests have been sent 950, the scheduling application 900 can wait to receive response SMS messages 960 from the contacted users. If all or a sufficient number of users have replied to the request, or a set time period has passed, the scheduling application 900 will check to see if the work has been accepted 970. If no users accept the work, or in the case when more than one worker is required at a given time only some of the places are accepted, the scheduling application can broaden the search preferences 980 and send another request 950. This may be achieved, for example, by searching for workers over a broader geographical area, repeating the database search to see if any new users have made themselves available at that time, or reducing or removing one of the other preference requirements (such as the required experience or qualifications requirement). In an alternate embodiment, this may include an auction process whereby a number of employers or schedulers may offer greater and greater incentives to work a specific event. The incentive may, for example, be in the form of a salary bonus. For example, in a retail application this might be used on Christmas Eve, when a retailer wants to insure sufficient staffing for last minute buyers. This may be repeated as many times as required to fill the positions.

In an alternative embodiment, if no, or too few, users accept the proposed work, the scheduling application 900 may simply send a message to the employer stating this, and allowing the employer to either accept the fewer staff or send out an additional search with broader preferences. This may be done after all, or a certain percentage, of users have responded, or at a given time after the request has been sent.

Once the proposed work has been accepted by the required number of users, the application can send a confirmation SMS message 990, and/or email or IM message, to the accepting users and/or the employer. In one embodiment, once users have accepted a proposed job, a confirmation message may include further instructions and/or information that the user may need prior to starting the job. These instructions may, for example, be inputted by the employer at the time the request was made, or after all places have been filled. Alternatively, the instructions could include more general information automatically generated by the scheduling application 900.

An example of a notification function for one embodiment of the invention can be seen in FIG. 10. In this embodiment 1000, a scheduler can enter the main menu 1010 and selects a schedule creation function 1020. The scheduler may then enter a Profile for Schedule section 1030, and create a blank schedule, or master schedule, 1050. To gain inputs from users, the scheduler can then send out one or more notifications 1060, alerting users to the ability to input desired times into the application prior to the finalization of the schedule. These notifications 1060 may be sent one or more times, and may contain information such as, but not limited to, the time and date in which the application will collate user responses and generate a finalized schedule. Once the notification time and date pass, the application can collate user responses 1070 and propose a finalized schedule for the scheduler to review and finalize 1075. If there are unfilled slots in the schedule, additional notifications of the remaining available schedules times may be sent 1080 until all available slots are filled 1085 and a finalized schedule is created. Additional notifications may be sent 1090, for example, to alert users that a finalized schedule is available for review 1095.

An alternative notification process including a replacement request function for one configuration of a scheduling application is illustrated in FIG. 11. Here, a user or employee can enter the applications 1100 main menu 1110, select his or her finalized schedule 1120, and request the application to find another user with which to trade the selected time period 1130 (also known as a Replacement Request). The application 1100 can review the users profile for this meeting or work time slot and automatically select (such as with preset parameters created by a user or scheduler) all appropriate users for whom a notification of the time slot availability should be sent. A request can be sent to all such user profiles using the appropriate communication mode for each individual user 1140. Once a user has responded and indicated a wish to make a trade 1150 (either for a different slot or simply to fill this additional time slot), the program will automatically confirm that acknowledgement 1160. This acknowledgement criteria may be of particular importance to communication methods such as SMS since not all such messages are delivered or received in a timely fashion. Once the substitute user confirms the replacement time slot, the trade occurs, and the finalized schedule is updated 1170. Additional confirmations or notifications may then be sent 1180, to the interested parties, such as, but not limited to, both users, others users who may have expressed interest in the trade, and/or the original scheduler.

An example of a user update process for one configuration of a scheduling application is shown in FIG. 12. In this embodiment, a user can select their profile schedule 1220 from the main menu function 1210. At this point, the user can simply update their availability (such as by adding additional times they wish to work, or removing times that they had previously made available for work) and/or select a notification for any new job request for that user 1230. It is envisioned that this type of updating may, in certain embodiments, occur fairly often.

The update process may also include a notification function that can be turned on and off by a user, allowing the user to control if and when job requests and/or notifications are sent to the user. In certain embodiments of the invention, the scheduling application may include a geographical aspect. This may, for example, include a user being able to store multiple addresses within their profile such that they can easily change their scheduling preferences as they move from one location to another. In one example, a student could include a home address and a university address, such that they may make themselves available for summer work and work during term time by simply selecting the address at which they are available at different times of the year. This may be beneficial, for example, if they use the scheduling application to work for a large company with a chain of stores (such as, but not limited to, retail stores or grocery stores) with stores at both the students home location and university location. The student may add geographic location information into their personal profile for an upcoming period of time, such that the application can provide location specific job requests at all times.

FIG. 13 shows another possible embodiment of the application. In this embodiment 1300, a user can log-in 1310 to the application 1300, and then either input contact information 1330, view and change schedules 1340, and/or input notification preferences 1350, such as the preferred communication method (including, but not limited to, e-mail, SMS, IM, or web communication) or whether to turn the notification function on or off at certain times. Example schedules that may be view and changed 1340 by the user may include, for example, a finalized schedule 1360 and/or a user preference schedule 1370.

FIG. 14A shows one example of a finalized group schedule 1410. FIG. 14B shows one example of an individuals schedule and preferences 1420. FIG. 14C shows another example of a group schedule 1430. Where appropriate, the user profiles associated with these profiles may or may not disclose actual contact information, as described above.

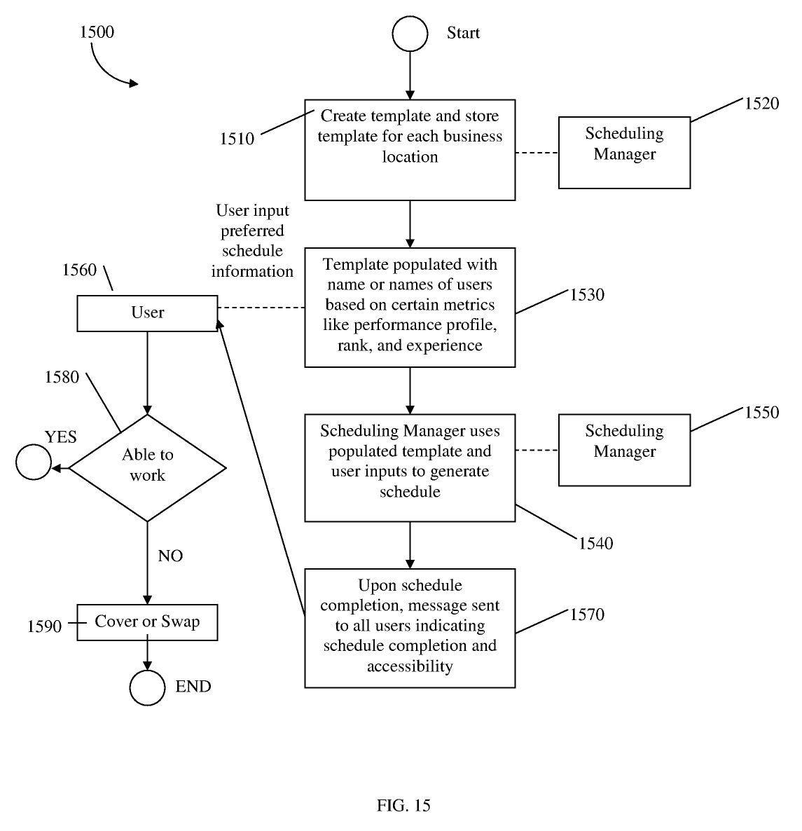

FIG. 15 shows a block diagram for one embodiment of a scheduling application. The application can function as a computer program stored in a PC, on a PDA, another appropriate wireless or handheld device, on another hardware platform, or as a web-based program, allowing information to be generated, communicated, and stored in any appropriate format, and allowing access from any appropriate device with access to a communications network, such as, but not limited to, the internet. The scheduling application can then be entered by either linking to it through a web page or loading a program that has been pre-installed on a PC or other appropriate wireless or wired device.

The block diagram of FIG. 15 shows the creation of a generic schedule template, its population of various types of information, the use of such information to create a schedule, and the communication of the finalization of such a schedule to other users. Once the scheduling application 1500 has been opened, a scheduling manager 1520 creates a scheduling template 1510 for each business location. The application then populates 1530 that scheduling template with the name or names of users based on one or more user scheduling preference inputs and certain metrics like a performance profile and ranking, experience. Metrics could be input by users 1560 or managers 1520, 1550 or automatically generated by the application based on certain behavioral tracking. User scheduling preference inputs could include information like when a given user or users want to work, can work but prefers not to, and cannot work. The application provides the populated template information to the scheduling manager 1550 to assist in creating a schedule 1540. The scheduling manager 1520 may be the same, or different than the scheduling manager 1550. Upon schedule completion 1570, the scheduling manager 1550 sends messages via the application to all users 1560 to notify them of the completion and availability of the schedule, and the ability of one of more users 1560 to work 1580. If any user is unable to work then they can initiate either a swap or coverage process 1590.

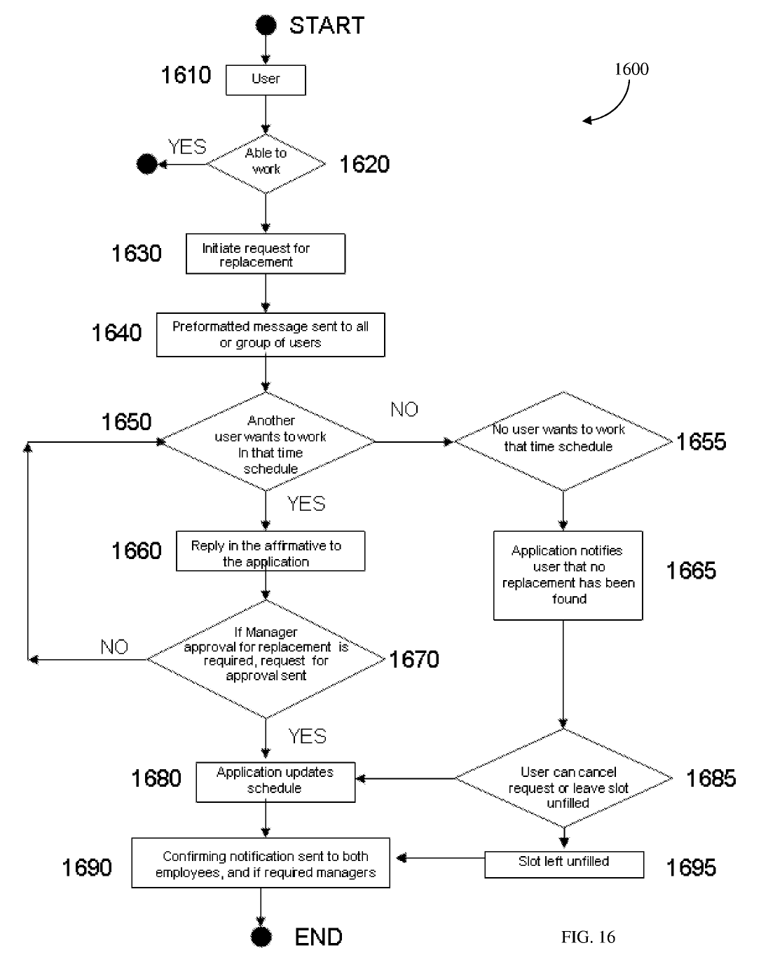

FIG. 16 shows a block diagram for one embodiment of a rescheduling function 1600 called Cover. In this instance a user 1610 can contact the application via various communication modes, request a replacement for a given scheduled time and gain coverage. Once user 1610 determines 1620 that they are unable to work a given time schedule, the scheduling application is contacted and a replacement requested 1630. The application sends out pre-formatted messages 1640 to all or a group of users requesting replacement. If another user is interested in working the requested replacement time 1650 he or she will reply in the affirmative 1660 via one of various communication modes to the application. In one embodiment of the invention, a manager's approval 1670 may be required for the replacement to be finalized, so in that event the application would contact the manager via various communication modes for his or her approval. If no such approval is required, the application updates the schedule 1680 and sends confirming notifications to all parties 1690. In the instance where a manager's approval is required, the manager may choose to approve the request and then the application proceeds to update 1680 and notify 1690 accordingly. However, if the manager chooses not to approve the replacement, then the application returns to step 1650 to find another replacement and follows the flow chart accordingly. In one embodiment of the invention, if for any reason, a replacement user is not found 1655, the application will notify the requesting user of that situation 1665. In such an instance the requesting user can then choose to cancel the replacement request 1685 and the application updates accordingly 1680, or the user may choose to take no action 1685 at which point the slot remains unfilled and is still the responsibility of the requesting user. In such an embodiment, the application may send a notification 1690 to the manager that an exchange had been requested but never fulfilled.

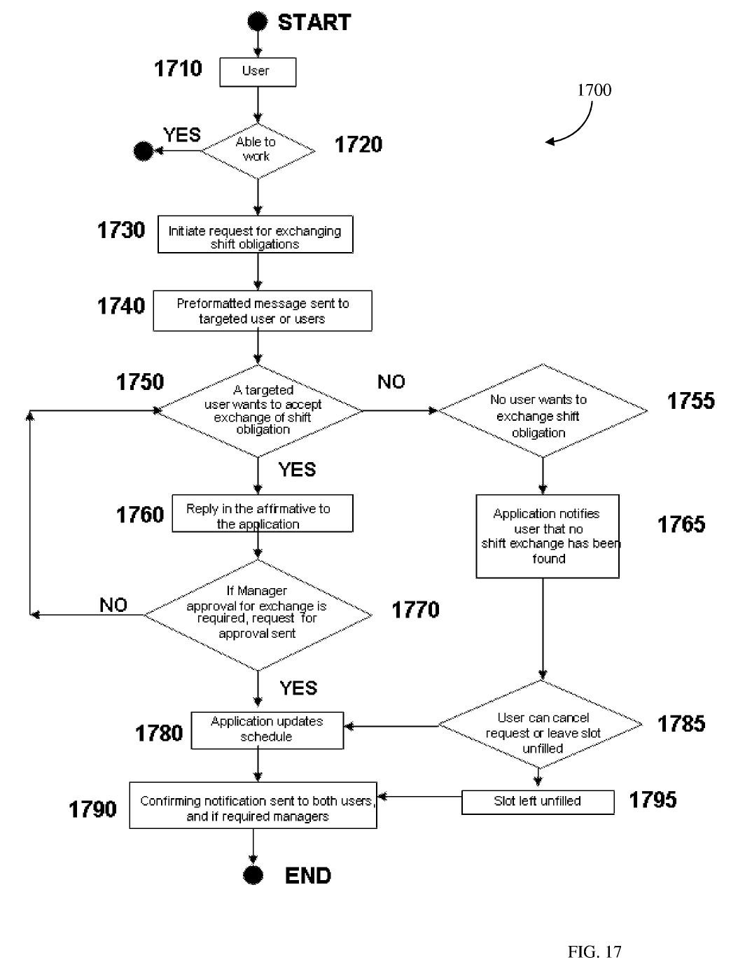

FIG. 17 shows a block diagram for one embodiment of a rescheduling function for swapping a task 1700. A swap differs from a cover in that a swap involves the exchange of two shifts between two different users, instead of the embodiment of FIG. 16 in which a simple replacement is found. For a swap, a user will contact the application via various communication modes, and request an exchange between two workers and two time slots. Once user 1710 determines that they are unable to work a given time schedule 1720 and that they would still like to work the same number of hours in that week, the scheduling application is contacted 1730 and the requesting user designates a desired time, or other user with whom to request an exchange. The application sends out pre-formatted messages 1740 to all targeted users for the exchange request. If another user is interested in accepting the exchange 1750 he or she will reply in the affirmative 1760 via one of various communication modes to the application. In one embodiment of the invention, a manager's approval 1770 may be required for the replacement to be finalized, so in that event the application would contact the manager via various communication modes for his or her approval. If no such approval is required, the application updates the schedule 1780 and sends confirming notifications to all parties 1790. In the instance where a manager's approval is required, the manager may choose to approve the request and then the application proceeds to update 1780 and notify 1790 accordingly. However, if the manager chooses not to approve the replacement, then the application returns to 1750 to find another user willing to exchange slots and follows the flow chart accordingly. In one embodiment of the invention, if for any reason, an exchange user is not found 1755, the application will notify the requesting user 1765 of that situation. In such an instance, the requesting user can then choose to cancel 1785 the exchange request and the application updates accordingly 1780, or the user may choose to take no action, at which point the slot remains unfilled 1795 and still the responsibility of the requesting user. In such an embodiment, the application may send a notification 1790 to the manager that an exchange had been requested but never fulfilled.

It should be understood that all embodiments, alternative embodiments, methods, and/or functions identified in each of the above-mentioned examples are applicable to all other embodiments described herein, and the invention can, in practice, include any appropriate combination of these functions and methods.

The invention may be embodied in other specific forms without departing form the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A method of scheduling a task, the method comprising the steps of:
receiving a task request from at least one requesting party, the task request comprising at least one task requirement;
providing a means of scheduling at least one worker to perform the task, the scheduling means comprising electronic communication;
sending at least one notification of the scheduling of the task, the notification comprising electronic communication; and
providing a means of updating the scheduling of the task, the updating means comprising electronic communication.

2. The method of claim 1, wherein the task requirement comprises at least one of a time, a date, a location, a skill set, a qualification, and a performance metric.

3. The method of claim 1, wherein means of communicating the electronic communications comprise at least one of an email message, an SMS message, a phone message, an instant message, a posted webpage message, an internet chat-room message, and a portal broadcast message to application users.

4. The method of claim 3, wherein a plurality of means of communicating the electronic communications may be used substantially simultaneously.

5. The method of claim 1, wherein at least one of the means of scheduling at least one worker and the means of updating the scheduling of the task comprises an at least partially automated process.

6. The method of claim 5, wherein at least one of the means of scheduling at least one worker and the means of updating the scheduling of the task further comprises an at least partially manual process.

7. The method of claim 6, wherein the at least partially manual process comprises an input from the at least one requesting party.

8. The method of claim 1, wherein the scheduling means comprises the steps of:
accessing information stored in a database for a scheduling application for at least one prospective worker;
generating a list of suitable prospective workers based on the information stored in the database;
sending a scheduling request to at least one of the suitable prospective workers through at least one electronic communication;
receiving a response from at least one of the selected suitable prospective workers; and
selecting at least one worker for the task based on the received responses.

9. The method of claim 8, wherein the at least one notification comprises an electronic communication to at least one of the requesting party, the at least one scheduled worker, and the selected suitable prospective workers.

10. The method of claim 8, wherein the information stored in the database comprises at least one of contact information, scheduling information, skill set information, qualification information, and performance metric information.

11. The method of claim 10, wherein the performance metric information comprises at least one of a timekeeping history, a performance history, a skill set, a willingness to accept tasks, and a willingness to perform accepted tasks.

12. The method of claim 1, wherein the rescheduling means comprises the steps of:
receiving a rescheduling request from at least one of the at least one requesting party and at least one scheduled worker;
accessing information stored in a database for a scheduling application for at least one prospective replacement worker;
generating a list of suitable replacement workers based on the information stored in the database;
sending a scheduling request to at least one of the suitable replacement workers through at least one electronic communication;
receiving a response from at least one of the selected suitable replacement workers; and
selecting at least one replacement worker for the task based on the received responses.

13. A method of scheduling coverage for a task, the method comprising the steps of:
storing schedule information for at least one worker in at least one database for a scheduling application;
receiving a coverage request from at least one requesting party, the coverage request comprising at least one task requirement;
matching the at least one task requirement with the stored schedule information to produce a list of suitable workers;
selecting at least one suitable worker from the list of suitable workers; and
providing a means for the at least one suitable worker to accept the task.

14. The method of claim 13, further comprising the step of providing a means for rescheduling a previously accepted task.

15. The method of claim 13, further comprising the step of providing a means for swapping one or more accepted tasks between suitable workers.

16. The method of claim 13, wherein the stored schedule information comprises at least one of contact information, scheduling availability information, skill set information, qualification information, and performance metric information.

17. The method of claim 16, wherein the selecting step comprises ranking the list of suitable workers according to at least one of the skill set information, the qualification information, and the performance metric information.

18. The method of claim 16, wherein the performance metric information comprises at least one of a timekeeping history, a performance history, a skill set, a willingness to accept tasks, and a willingness to perform accepted tasks.

19. The method of claim 16, further comprising the step of providing a means for updating at least one piece of the stored schedule information for the at least one worker.

20. The method of claim 19, wherein the at least one piece of stored schedule information can be updated by at least one of the at least one worker and the at least one requesting party.

21. The method of claim 13, wherein at least one of the receiving step, the matching step, the selecting step and the providing step is at least partially automated.

22. The method of claim 20, further comprising the steps of:
analyzing at least one of the stored schedule information, a database of stored task request information, and a database of stored task acceptance information;
creating a heuristical model in response to the analyzed information; and
incorporating the heuristical model into a means of executing the at least one partially automated step.

23. The method of claim 20, further comprising the steps of:
analyzing data associated with the usage of at least one function of the scheduling application;
creating a heuristical model in response to a pattern of usage; and
incorporating the heuristical model into a means of executing the at least one partially automated step.

24. The method of claim 13, wherein at least one of the at least one database and the scheduling application is stored on a portable electronic device.

25. The method of claim 13, further comprising the step of providing a means for communicating advertising information to the at least one worker in the at least one database.

26. A task scheduling system, comprising:
at least one database adapted to store scheduling information for at least one worker; and
a scheduling application for scheduling at least one task, the scheduling application comprising:
a means of retrieving scheduling information stored in the at least one database;
a means of receiving a coverage request from at least one requesting party, the coverage request comprising at least one task requirement;
a means of matching the at least one task requirement with the stored schedule information to produce a list of suitable workers;
a means of selecting at least one suitable worker from the list of suitable workers; and
a means for the at least one suitable worker to accept the task.

27. The task scheduling system of claim 26, further comprising a means of updating scheduling information stored in the at least one database.

28. The task scheduling system of claim 26, further comprising a means for rescheduling a previously accepted task.

29. The task scheduling system of claim 26, further comprising a means for swapping one or more accepted tasks between suitable workers.

30. The task scheduling system of claim 26, further comprising a means for storing a plurality of separate job schedules for the at least one worker.

31. The task scheduling system of claim 30, wherein the means for storing the plurality of separate job schedules further comprises a means of collating at least two of the plurality of separate job schedules into a single calendar for review by the at least one worker.

32. The task scheduling system of claim 30, further comprising a means of prioritizing one or more job schedules within the plurality of separate job schedules.
